(19) United States
(12) Patent Application Publication
(10) Pub. No.: US 2016/0259333 A1
(43) Pub. Date: Sep. 8, 2016

(54) LANDING SYSTEM FOR VERTICAL TAKE-OFF AND LANDING AIRCRAFT

(71) Applicant: Hoverfly Technologies, Inc., Orlando, FL (US)

(72) Inventor: Alfred D. Ducharme, Oviedo, FL (US)

(21) Appl. No.: 15/056,823

(22) Filed: Feb. 29, 2016

Related U.S. Application Data
(60) Provisional application No. 62/121,635, filed on Feb. 27, 2015.

(51) Int. Cl. G05D 1/00; G01S 17/08; G05D 1/08; B64C 29/00; B64C 27/08

(52) U.S. Cl. CPC G05D 1/0033; B64C 29/0091; B64C 27/08; G05D 1/0858; G01S 17/08

(57) ABSTRACT

A system for landing a vertical take-off and landing aircraft includes a vertical take-off and landing aircraft, the aircraft having a light signal emitter. A landing station, has a camera including a lens for receiving the light signal emitted from the vertical take-off and landing aircraft. The landing station determines a normal line to the lens. The vertical take-off and landing aircraft communicates with the base The base receives the light signal at the camera and determines a lateral distance between the normal line and the aircraft. The landing station sends a control signal to the aircraft causing the aircraft to reduce the lateral distance between the aircraft and the normal line.

### CROSS-REFERENCE TO RELATED APPLICATIONS

The subject invention claims the benefits of priority to U.S. Provisional patent Application Ser. No. 62/121,635, filed Feb. 27, 2015, the disclosure of which is herein incorporated by reference in its entirety.

### BACKGROUND OF THE INVENTION

The present application is directed to a vertical take-off and landing aircraft landing system with high accuracy, and more particularly, a vertical take-off and landing aircraft landing system utilizing vision guidance to increase the accuracy of landings.

Vertical take-off and lift (VTOL) multiple rotor aircraft are known in the art. Landing of such aircraft is usually done by the visual control of an operator, bringing a VTOL multiple rotor aircraft to a desired spot capable of being seen either with actual eyes or through monitors. This system has been satisfactory; however, it requires the outrigger to be on sight of the landing field or have a visual connection through the cameras or the like mounted on the VTOL. This method suffers from the disadvantage of putting the operator in harms way to the landing sight, or the requiring of additional weight on the VTOL for the camera and associated circuitry.

It is also known in the art to utilize geopositioning satellites for terrestrial navigation to determine the relative position of the VTOL to a landing sight and to use the current position of the VTOL as determined by GPS to autonomously guide the VTOL to the landing sight. This method has also been satisfactory, however it suffers from the disadvantages that these GPS landing systems have an accuracy as large as three meters in diameter. While precision can be much better over short periods of time, the amount of error in accuracy can change suddenly without warning, often causing harm to the VTOL where a safe landing area has a surface area of less than 9 meters squared.

Accordingly, it is an object of the present invention to provide a system and method to guide a VTOL aircraft to a landing area with high precision and accuracy automatically without the need for human intervention.

### SUMMARY OF THE INVENTION

A system for landing a vertical take-off and landing aircraft comprises a marking such as a beacon on the aircraft, the beacon outputting an infrared signal. The marking could also consist of any light reflecting or emitting fiducial. The system further having a landing station having a lens, an image sensor array, and a microprocessor. The lens receiving the aircraft beacon signal or fiduciary and focusing the aircraft beacon onto the image sensor array, the array outputting a signal corresponding to an X-coordinate and Y-coordinate position of the beacon (and thus the craft) origination point. The microprocessor, receiving the X-coordinate and Y-coordinate and an altitude of the aircraft beacon from the imaging sensor array, determines an angle of the aircraft beacon from a normal line relative to the plane of the image sensor array, and determines distance and direction of the aircraft beacon from the normal to the imaging sensor array. The microprocessor causes an adjustment command to be sent to the aircraft to minimize the positional difference between the aircraft beacon and the normal line.

### BRIEF DESCRIPTION OF THE DRAWINGS

For a fuller understanding of the invention, reference is had to the following description taken in connection with the accompanying drawings in which:

FIG. 1 is a schematic drawing of the system for landing a vertical take-off and lift aircraft constructed in accordance with the invention;

FIG. 2 is a more detailed schematic sectional view of a landing station constructed in accordance with the invention;

FIG. 3 is a flow chart for the operation of accurately landing a vertical take-off and lift aircraft in accordance with the invention; and

FIG. 4 is an algorithm for creating the commands to move the aircraft towards the normal line of an imaging sensor array in accordance with the invention.

### DETAILED DESCRIPTION OF THE INVENTION

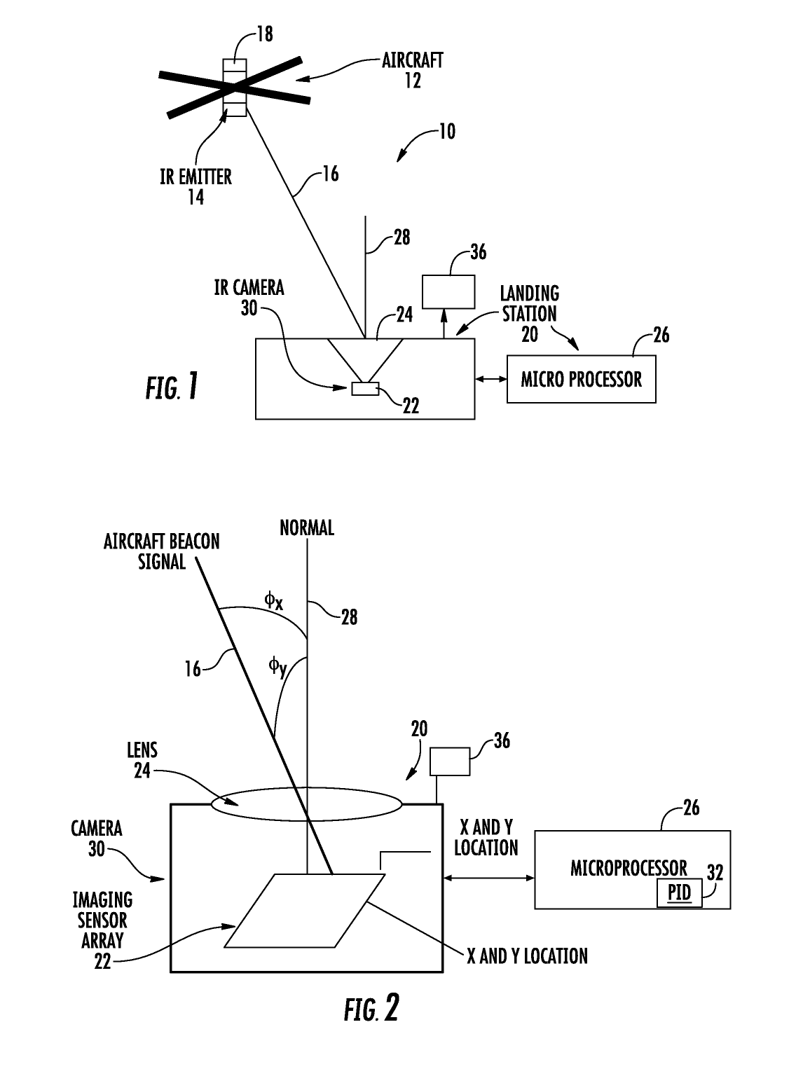

Reference is first made to FIG. 1 in which a landing system, generally indicated as 10, constructed in accordance with the invention, includes a landing station 20 communicating with an aircraft 12. Aircraft 12 is a vertical take-off and lift aircraft (VTOL), and a multiple rotor aircraft in a preferred but non-limiting embodiment. Aircraft 12 includes a directional light signal emitter 14, in a preferred but non-limiting embodiment, emitter 14 is an infrared (IR) emitter which emits a directional signal 16 towards the ground, however an ultraviolet light emitter or visible light emitter may be used as well.

System 10 includes a landing station 20 having a camera 30 with spectral sensitivity in the wavelength range of aircraft 12 and receiving a signal being output by a lighted beacon 14. Again, in the preferred non-limiting embodiment, the lighted beacon 14 is an infrared lighted beacon, but landing station may 20 also operate, as discussed below on ultraviolet light and visible light.

The landing station 20 (FIG. 2) has an infrared camera 30; a communicator 36, and a microprocessor 26. Infrared camera 30 includes an imaging sensor array 22 and a lens 24 for focusing and receiving a directional infrared signal 16 from aircraft 12. As will be described in detail below, landing station 20 utilizes the received directional signal 16 to determine a relative three dimensional position of aircraft 12; acting as a virtual compass. Imaging sensor array 22 converts the directional signal 16 into an X-position coordinate and Y-position coordinate. Landing station 20 further includes a microprocessor 26 for processing the X, Y coordinates. The microprocessor 26 stores the orientation of a line normal to lens 24; a normal line 28.

During operation, aircraft 12 emits a directional signal 16 such as an infrared signal from an infrared emitter (not shown) of lighted beacon 14. Landing station 20, acting as a virtual pilot, observes the signal 16 from the infrared emitter 14, calculates position corrections relative to a normal 28 relative to the landing station landing surface, and sends flight adjustment commands to aircraft 12.

The infrared images received by imaging sensor array 22, once focused by lens 24, are processed by an imaging sensor array 22 to determine the image to image translation of the aircraft infrared signal 16 emitted by infrared emitter (beacon) 14. This can be done by comparing imaging sensor array 22 outputs of an X-plane and Y-plane location of the infrared beacon 14 image on the imaging sensor 22. While an infrared camera is used by way of non-limiting example, any light signal detector capable of determining the X, Y coordinates of the source may be used for reasons described below.

Microprocessor 26 utilizes known information regarding the physical characteristics, focusing properties and position and orientation of camera lens 24 to translate the X,Y coordinate image centroid location into angles relative to normal 28. These angles correspond to Øx and Øy angles of the aircraft 12 from the normal 28 centered on lens 24.

Aircraft 12, as known in the art, has an onboard compass, in a preferred non-limiting embodiment an electronic compass such as a magnometer to determine X,Y coordinates of aircraft 12 relative to the ground. A microprocessor 18 mounted on aircraft 12 determines altitude information and compass bearing of the aircraft 12; and communicates this information to landing station 20. Microprocessor 26 calculates a distance and direction of aircraft 12 from the normal 28 to lens 24 as a function of the received altitude, compass and calculated angles relative to normal.

Reference is now made to FIG. 3 in which the method of operation for system 10 is provided. Generally, microprocessor 26 uses distance and direction of the aircraft 12, as determined from aircraft beacon signal 16, from normal 28 as a positional error. Proportional integral derivative controllers (PID controller) 32 within microprocessor 26 are utilized to calculate roll and pitch aircraft adjustments required to minimize the positional error of the aircraft 12. These adjustments are provided as commands and output by communicator 36 as a command signal to aircraft 12 to adjust the operation of the propellers on VTOL aircraft 12. Communicator 36 may utilize a wireless or wired communication path.

PID controller 32 determines the translational velocity in X and Y directions required to move aircraft 12 towards normal 28. More particularly, as seen in FIG. 3, aircraft 12 initiates a landing sequence once the on-board navigation system determines that the approximate landing area has been reached. A landing signal is communicated between aircraft 12 and landing station 20 utilizing communicator 36 to acknowledge that the roll and tilt control of aircraft 12 is to be controlled by landing station 20 in a step 42. In step 44 the X-position and Y-position of aircraft 12 is determined by image sensor array 22 receiving the aircraft beacon signal 16 through lens 24. The altitude of aircraft 12 is determined and recorded by microprocessor 26 in a step 46. Microprocessor 26 calculates a lateral distance between the position of aircraft 12 and the landing station normal 28 in a step 48. The proportional integral derivative controllers calculate the roll and pitch aircraft adjustment requirements to minimize the positional error of aircraft 12 relative to normal 28 as a function of the altitude, X-position and Y-position in a step 50.

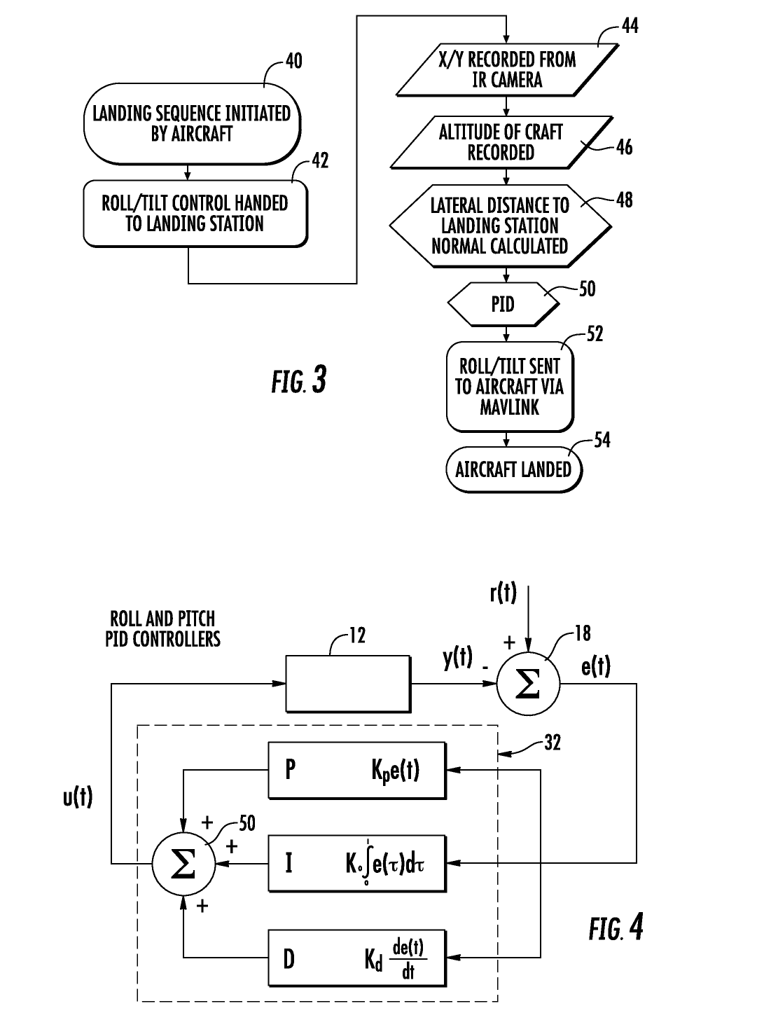

Reference is now made to FIG. 4 in which the operation of the PID 32 is shown in detail. To improve accuracy of the landing of aircraft 12, aircraft 12 is continuously adjusting for an error e(t) which is the error in velocity between a needed velocity to align with normal 28 and the actual velocity or resulting velocity of aircraft 12 as measured; y(t). Therefore, a feedback loop system is employed by microprocessor 26, the resulting velocity u(t), in other words, the velocity required to move aircraft 12 towards the normal line 28 is continuously calculated and updated. This is determined as a function of a measured error signal e(t) which is the error in velocity between the calculated needed velocity r(t) and a resulting velocity y(t), which is the measured velocity of aircraft 12. In order to minimize the error in velocity, instruction signals are communicated to aircraft 12 to control the roll and pitch of aircraft 12.

Microprocessor 26 through PID controller 32, utilizes the error signal to calculate proportional gains Kₚ, Kᵢ, and K_{d} required to minimize the error signal, in other words, drive the error signal e(t) towards zero over time. Proportional gains are combined by PID 32 utilizing a processor 50 to create the control output for controlling the roll/tilt of aircraft 12 as transmitted as a control signal by communicator 36. Upon receipt of the PID controller u(t), the aircraft 12 adjusts the velocity of aircraft 12. The resulting velocity exhibited by aircraft 12, y(t), is measured and a next error signal is calculated as a function of the measured y(t) and the newly calculated r(t) by microprocessor 18 to output and be combined with an updated error signal e(t) which is input to PID 32 for feedback adjustment narrowing the error signal.

As a result, when aircraft 12 is far away from normal 28, the velocity is increased in a direction towards normal 28. Once the aircraft arrives at normal 28, the velocity of aircraft 12 and error go to zero. The PID controller 32 maintains the aircraft centered on the normal line 28. The operation of the PID controller can be expressed as:

$$u ( t ) = MV ( t ) = {K}_{p} e ( t ) + {K}_{i} {\int }_{0}^{t} e ( τ ) d τ + {K}_{d} \frac{d}{d t} e ( t )$$

Returning to FIG. 3, once the control signal u(t) is calculated, the roll/tilt signal determined from the u(t) value, are sent to aircraft 12 by communicator 36. The values of roll and tilt adjustment are calculated by the microprocessor 26 based on the current compass orientation of the aircraft. A large roll or tilt adjustment signal corresponds to a greater velocity required. Whereas a small roll and tilt adjustment corresponds to a small velocity required. This process is repeated by returning to step 44 until aircraft 12 is landed in a step 54.

It should be noted that normal 28 to landing station 20, is also the normal to the ground when the ground is relatively parallel with the horizon. However, if the landing station 20 is on the side of a hill, or on a rolling ship, the normal to the landing station, may be at an angle making it difficult, if not impossible to land. Therefore, a sensor for determining the orientation of landing station 20 to the horizon is utilized. In a preferred, non-limiting embodiment an accelerometer is used to determine the relative orientation of landing station 20 to the gravitational force of the Earth. This value is then used to readjust the normal 28 used for the above calculations.

While this invention has been particularly shown and described to reference to preferred embodiments thereof, it would be understood by those skilled in the art that various changes in form and details may be made therein, without departing from the spirit and scope of the invention encompassed with the appended claims.

What is claimed as new and desired to be protected by Letters Patent is:

1. A system for landing a vertical take-off and landing aircraft comprising:
a vertical take-off and landing aircraft, exhibiting a velocity and having a light signal emitter; and
a landing station, the landing station having a camera therein including a lens for receiving a light signal emitted from the vertical take-off and landing aircraft; the landing station determining a normal line to the lens; and the vertical take-off and landing aircraft communicating with the base, the base receiving the light signal at the camera and determining a lateral distance between the normal line and the aircraft, the landing station sending a control signal to the aircraft causing the aircraft to reduce the lateral distance between the aircraft and the normal line.

2. The system for landing a vertical take-off and landing aircraft of claim 1, wherein the vertical takeoff and landing aircraft determines an altitude and a compass bearing of the vertical takeoff and landing aircraft and transmits the altitude and the compass bearing to the landing station, the landing station determining a distance and direction of the vertical takeoff and landing aircraft from the normal as a function of the altitude and compass bearing.

3. The system for landing a vertical take-off and landing aircraft of claim 1, wherein the light signal emitter is an infrared light signal emitter.

4. The system for landing a vertical take-off and landing aircraft of claim 1, wherein the landing station determines a roll adjustment and a pitch adjustment for the vertical takeoff and landing aircraft to minimize a positional error between a position of the vertical takeoff and landing aircraft and the normal line.

5. The system for landing a vertical take-off and landing aircraft of claim 4, wherein the control signal includes the roll adjustment and the pitch adjustment.

6. A landing station for landing a vertical take-off and landing aircraft comprising:
a camera including a lens for receiving a light signal emitted from the vertical take-off and landing aircraft;
a processor, the camera receiving the light signal at the camera and the processor determining a lateral distance between a normal line, normal to the lens, and the vertical take-off and landing aircraft as a function of the light signal, and creating a control signal as a function of the lateral distance; and
a communicator, the communicator sending the control signal to the aircraft to cause the aircraft to reduce the lateral distance between the aircraft and the normal line.

7. The landing station of claim 6, wherein the communicator receives an altitude and a compass bearing of the vertical take-off and landing aircraft, and the processor determining a distance and direction of the vertical takeoff and landing aircraft from the normal as a function of the altitude and compass bearing.

8. The landing station of 6, wherein the light signal is an infrared light signal.

9. The landing station of claim 6, wherein the processor determines a roll adjustment and a pitch adjustment for the vertical takeoff and landing aircraft to minimize a positional error between a position of the vertical takeoff and landing aircraft and the normal line.

10. The landing station of claim 9, wherein the control signal includes the roll adjustment and pitch adjustment.

11. A vertical take-off and landing aircraft comprising:
a light signal emitter for emitting a light signal to a landing station; the vertical take-off an landing aircraft enabling control of the vertical take-off an landing aircraft by the base station in response of a control signal, and the aircraft to reducing the lateral distance between the aircraft and a line normal to a lense of the landing station in response to the control signal, the control signal being created as a function of the receipt of the light signal.

12. The vertical take-off and landing aircraft of claim 11, further comprising a processor for determining an altitude and a compass bearing of the vertical take-off and landing aircraft.

13. The vertical take-off and landing aircraft of claim 11, wherein the control signal includes a roll adjustment and a pitch adjustment for the vertical take-off and landing aircraft to minimize a positional error between a position of the vertical takeoff and landing aircraft and the normal line.
